(19) United States
(12) Patent Application Publication
(10) Pub. No.: US 2010/0224019 A1
(43) Pub. Date: Sep. 9, 2010

(54) DRIVER UNIT WITH A THRUST WASHER AND METHOD FOR MANUFACTURING THE SAME

(76) Inventors: Thomas Huck, Rheinmuenster (DE); Tarek Mili, Karlsruhe (DE); Diyap Bueyuekasik, Buehl (DE); Rico Lampert, Plymouth, MI (US)

Correspondence Address: MICHAEL J. STRIKER, 103 EAST NECK ROAD, HUNTINGTON, NY, 11743, US

(21) Appl. No.: 12/063,098

(22) PCT Filed: May 4, 2007
(86) PCT No.: PCT/EP07/54367

§ 371 Date: Feb. 6, 2008

(30) Foreign Application Priority Data
May 11, 2006 (DE) 10 2006 021 986.4

(51) Int. Cl. F16H 1/16; H02K 7/116

(52) U.S. Cl. 74/425; 310/83

(57) ABSTRACT

The invention relates to a drive unit (10) and to a method for producing the same, in particular for adjusting moveable parts in a motor vehicle, having a metal driveshaft (17) which is mounted in a housing (11) by means of at least one radial bearing element (28), wherein the driveshaft (17) has two end sides (42), at least one of which, as an axial stop, is supported on the housing (11) by means of a stop disk (44), wherein the stop disk (44) is produced from a self-lubricating material (49) which lubricates the axial stop over the entire service life of the drive unit (10) without the use of additional, separate lubricants.

### RELATED ART

The present invention relates to a drive unit, in particular for adjusting movable parts in a motor vehicle, and a method for manufacturing such a drive unit with a thrust washer for the drive shaft, according to the one of the independent claims.

Publication DE 102 35 365 A1 made known a servo unit, in the case of which an electric motor drives an armature shaft. A worm is located on the armature shaft, which meshes with a worm gear and provides output torque to a driven pinion. The armature shaft is supported axially at its end faces via thrust washers, relative to which the cap-shaped ends of the armature shaft rotate. To minimize the wear of the thrust washers, the cap-shaped ends of the armature shaft are optimized. With this servo unit, the thrust washers are installed axially into related receptacles in the pole pot or the transmission housing. To minimize the friction between the stop caps and the thrust washers, grease is deposited in these receptacles for lubrication, which is an additional working step that must be carried out. In addition, with a servo unit of this type, there is a risk that the amount of lubricant on the friction surface between the thrust washer and the end of the armature shaft will be inadequate for the entire service life of the drive. The thrust washers may become damaged as a result.

### DISCLOSURE OF THE INVENTION

The inventive drive unit and the manufacturing method with the characterizing features of the independent claims have the advantage that, by manufacturing the thrust washer using a self-lubricating material, it is ensured that reliable lubrication will always exist between the thrust washer and the end face of the drive shaft, for the entire service life of the drive unit. By using a self-lubricating material, it may be ensured that the lubricant will not flow out, e.g., if overheating occurs. Moreover, an additional process step is eliminated that would otherwise be required to deposit the lubricant in the region of the thrust washer, in the case of typical drive units.

Due to the measures listed in the dependent claims, advantageous refinements and improvements of the features described in the independent claims are made possible. When the self-lubricating material includes a plastic matrix, the lubricant may be reliably embedded therein. By integrating the lubricant in the matrix of the carrier material, it may be easily guaranteed that the lubricant will not volatize during operation.

A self-lubricating thrust washer may be manufactured in a particularly favorable manner using an injection-molding procedure, since the lubricant is incorporated evenly in the plastic matrix in one working step throughout the entire volume of the thrust washer. As a result, the surface of the thrust washer is lubricated, and lubricant is always provided at the friction surface if the interior of the thrust washer should become worn.

It is advantageous to embed Teflon or graphite as the lubricant in the matrix of the thrust washer, because they are retained in the matrix particularly well and have very is good lubricating properties.

The assembly of the drive unit becomes particularly favorable when the drive shaft may be installed—with its entire length—in a housing part, and when the thrust washers may be installed in a housing part, radially relative to the armature shaft. The thrust washers are advantageously secured in position in the receptacles when the housing is closed radially.

To ensure that the thrust washer does not rotate with the drive shaft, the thrust washer includes a rectangular profile around its circumference, which creates a form-fit connection with a corresponding rectangular profile of the receptacle. It is particularly easy to design the polygonal profile as a rectangle.

When insertion chamfers that interact with corresponding phases of the receptacles in the housing upon insertion are integrally formed on the thrust washer, the radial assembly of the thrust washers is greatly simplified.

It is particularly advantageous to use the self-lubricating thrust washers for an armature shaft with a worm gear pair, since large axial and radial forces act on the ends of the armature shaft.

When the drive is operated in both directions of rotation, high axial loads occur on both end faces of the drive shaft. Two identical thrust washers may therefore be installed on both end faces of the drive shaft, thereby making the assembly process more cost-effective.

When the housing is designed in the shape of a shell, thereby enabling the entire length of the drive shaft to be installed radially in a first housing part, the two self-lubricating thrust washers may also be inserted in the same assembly direction. The use of a self-lubricating thrust washer advantageously eliminates the need for an additional assembly step to lubricate the thrust washers.

Exemplary embodiments of the inventive device are presented in the drawing and are described in greater detail in the description below.

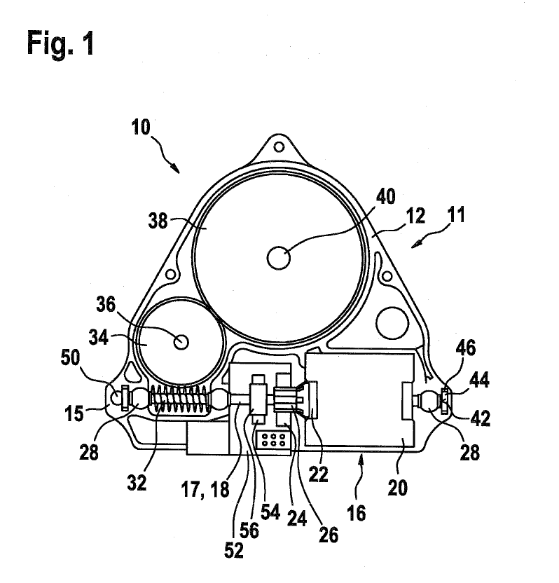

FIG. 1 shows a view of an inventive drive unit in the opened state, and

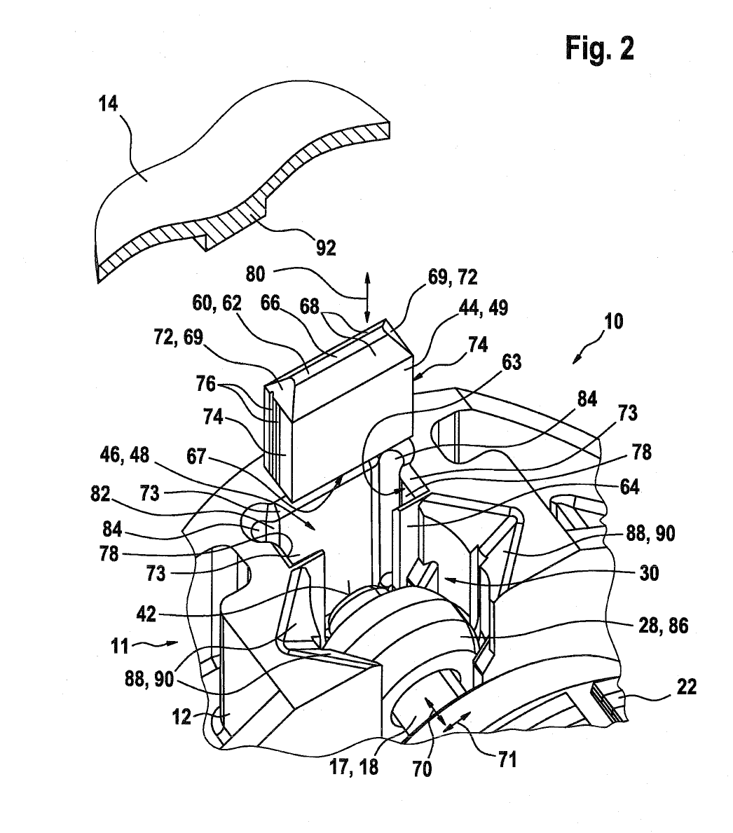

FIG. 2 shows the installation of the thrust washer in detail.

### DESCRIPTION OF THE EXEMPLARY EMBODIMENTS

FIG. 1 shows a drive unit 10, with which an electric motor 16 with a drive shaft 17 is located in a first housing part 12 of a housing 11. Electric motor 16 includes permanent magnets 20, which are non-rotatably mounted in housing 11 and set an armature 22 into rotation. Armature 22 is commutated via a collector 26, using brushes 24. An electronics unit 52 is located in the region of a collector 26, which registers a position signal of a signal transducer 56 using a sensor system 54. Bearings 28 are located on drive shaft 17, which is designed as an armature shaft 18. Bearings 28 are inserted, e.g., directly in related bearing receptacles 30 in housing 11. Armature shaft 18 also includes a worm 32, which meshes with a worm gear 34 located on a first bearing axis 36. In a further gear stage, torque is transferred from worm gear 34 to an output element 38 located on a second axis 40. Drive shaft 17 is inserted with its entire length radially into first housing part 12. Drive shaft 17 includes end faces 42 on its ends, which bear against thrust washers 44. Thrust washers 44 are also inserted radially into receptacles 46, which, in the present exemplary embodiment, are designed as pockets 48 directly in housing 11. Thrust washers 44 have a polygonal circumference 62 that, together with housing 11, forms a rotation lock for thrust washer 44. Thrust washers 44 are made of a self-lubricating material 49, in the case of which a lubricant is embedded directly in a matrix structure of thrust washer 44. The carrier material that forms a matrix is, e.g., a polyamide plastic in which Teflon (PTFE) or graphite is integrated as the lubricant. It is also possible to embed silicone, molybdenum disulphide or similar lubricants evenly in the carrier material, throughout the entire volume of thrust washer 44. Self-lubricating thrust washer 44 is preferably manufactured using a plastic injection-molding procedure, with which the granulate itself that is used is a mixture of the plastic carrier material and the related lubricants. Drive shaft 17 is made, e.g., of steel, thereby ensuring that the friction between end faces 42 and thrust washers 44 is minimal, without the application of additional lubricants. To compensate for axial play, in the present exemplary embodiment, a damping element 50 is located between a housing wall 15 and the side of thrust washer 44 facing away from end face 42, and which is preloaded upon installation.

FIG. 2 shows an enlarged view of a further drive unit 10. For simplicity, thrust washer 44 is shown in the pre-installed state. In this case, thrust washer 44 is designed nearly as polygon 60 with a polygonal circumference 62, which creates a form-fit connection with related polygonal recess 63 of receptacle 46 in housing 11. In the specific case, polygon 60 is designed as a rectangle 58 with a nearly rectangular circumference 62. Receptacle 46 includes axial wall sections 64, thereby ensuring that thrust washer 44 also creates an axial form-fit connection with housing 11. On its top side 66 and bottom side 67, thrust washer 44 includes an insertion chamfer 68, which is slanted in axial direction 70. Slanted surfaces 72—as further insertion chamfers 69—are also formed in a direction 71 transverse to drive shaft 17. Surfaces 72 simplify insertion in pocket 48. Corresponding, slanted insertion surfaces 73 are also formed on receptacle 46, so that, when thrust washer 44 is installed radially, it is also inserted squarely into receptacles 46 with large assembly tolerances. For fixation in transverse direction 71, clamping edges 76 are integrally formed with lateral surfaces 74 of thrust washer 44. Clamping edges 76 bear against opposite side walls 78 of receptacle 46. Openings 84 are formed in receptacle 46, on edges 82 along radial direction 80. Openings 84 prevent thrust washer 44 from tilting when it is installed radially.

In the present exemplary embodiment, bearings 28 are formed as calotte bearings 86, which are also inserted in bearing receptacle 30 in radial direction 80. To this end, bearing receptacle 30 includes slanted surfaces 90 as insertion aid 88. Surfaces 90 allow calotte bearing 86 to glide into bearing receptacle 30 when it is installed radially.

With the inventive manufacturing method, thrust washers 44 and drive shaft 17 are inserted with bearings 28 in first, shell-shaped housing part 12, in radial direction 80. First housing part 12 is then closed with a second housing part 14, which is designed as a cover. Second housing part 14 presses thrust washers 44 radially into related receptacles 46. To this end, stop elements 92 are located, e.g., on second housing part 14, which bear against thrust washer 44 in radial direction 71. At the same time, and as an option, bearings 28 are pressed via second housing part 14 into related bearing is receptacles 30.

It should be noted that, with regard for the exemplary embodiments presented in the figures and the description, many different combinations of the individual features are possible. For example, the specific design of the form-fit rotational lock may be varied, by designing polygonal circumference 62, e.g, as a triangle, a pentagon, or a hexagon. As an alternative, this form-fit connection may also include curved circumferential surfaces, e.g., an oval. Likewise, insertion chamfers 68, 69 and/or slanted surfaces 73 of receptacle 46 may be adapted to the assembly requirements. The present invention is not limited to the use of calotte bearings 86 or a worm gear pair, although it is preferably used for servo units in a motor vehicle, e.g., for power windows, power sunroofs, or seat adjusters.

What is claimed is:

1. A drive unit (10), in particular for adjusting movable parts in a motor vehicle, with a drive shaft (17) composed of metal, which is supported in a housing (11) using at least one radial bearing element (28), and which includes two end faces (42), at least one of which bears, as an axial bearing, against the housing (11) via a thrust washer (44),
wherein
the thrust washer (44) is made of a self-lubricating material (49) that lubricates the thrust washer for the entire service life of the drive unit (10) without the use of additional, separate lubricants.

2. The drive unit (10) as recited in claim 1,
wherein
the material (49) of which the thrust washer (44) is composed includes a plastic matrix in which a lubricant is integrated.

3. The drive unit (10) as recited in claim 1,
wherein
the lubricant is embedded in the plastic matrix using an injection-molding process throughout the entire volume of the thrust washer (44).

4. The drive unit (10) as recited in claim 1,
wherein
Teflon or graphite are integrated in the thrust washer (44) as the lubricant.

5. The drive unit (10) as recited in claim 1,
wherein
the housing (11) includes a first housing part (12) and a second housing part (14), which may be joined radially relative to the drive shaft (17), the housing (11) including a pocket-shaped receptacle (46) in which the thrust washer (44) may be installed radially, and which may be pressed into the receptacle (46) using a radial projection (92) of the second housing part (14).

6. The drive unit (10) as recited in claim 1,
wherein
the thrust washer (44) has a polygonal geometry (62) around its circumference, in particular essentially a rectangle (60), which serves as a rotation lock and creates a form-fit connection with a corresponding geometry (63) of the receptacle (46).

7. The drive unit (10) as recited in claim 1,
wherein
the thrust washer (44) includes at least one insertion chamfer (68, 69), which centers the thrust washer (44) in the axial direction (70) and transversely to the drive shaft (17) upon installation in the receptacle (46).

8. The drive unit (10) as recited in claim 1,
wherein
the drive shaft (17) is designed as an armature shaft (18) of an electric motor (16), on which, in particular, a worm (32) for meshing with a worm gear (34) is located.

9. The drive unit (10) as recited in claim 1,
wherein
the drive shaft (17) is designed to be reversible, with its entire length located between the two housing parts (12, 14), and including identical thrust washers (44) in identical receptacles (46) on each of its end faces (42).

10. A method for manufacturing a drive unit (10), in particular as recited in claim 1, with at least one lower housing part (12) and an upper housing part (14), and a drive shaft (17), which is supported in the housing parts (12, 14) via at least one thrust washer (44), characterized by the following assembly steps:
The at least one thrust washer (44) is designed to be self-lubricating and is inserted radially into a receptacle (46) of the lower housing part (12), creating a form-fit connection in the circumferential direction
The drive shaft (17) is inserted radially with at least one bearing element (28) in the lower housing part (12) such that at least one end face (42) of the drive shaft (17) bears against the at least one thrust washer (44), without the addition of a separate lubricant
The upper housing part (14) is placed radially on the lower housing part (26) and is connected therewith; the thrust washer (44) is pressed into the receptacle (46) in order to fix the thrust washer (44) in position.
